(19) United States
(12) Patent Application Publication
(10) Pub. No.: US 2024/0131774 A1
(43) Pub. Date: Apr. 25, 2024

(54) RESIN CONTAINER MANUFACTURING METHOD AND MANUFACTURING APPARATUS

(71) Applicant: NISSEI ASB MACHINE CO., LTD., Nagano (JP)

(72) Inventors: Toshiteru OIKE, Nagano (JP); Kazuya ISHIZAKA, Nagano (JP)

(73) Assignee: NISSEI ASB MACHINE CO., LTD., Nagano (JP)

(21) Appl. No.: 18/281,657

(22) PCT Filed: Mar. 13, 2022
(86) PCT No.: PCT/JP2022/011443

§ 371 Date: Nov. 30, 2023

(30) Foreign Application Priority Data
Mar. 14, 2021 (JP) 2021-041526

(51) Int. Cl. B29C 49/30; B29B 11/08; B29B 11/16; B29C 49/42

(52) U.S. Cl. CPC B29C 49/30; B29B 11/08; B29B 11/16; B29C 49/42412; B29C 2049/023

(57) ABSTRACT

A producing method for a resin container includes a first injection molding step of injection-molding an intermediate molded body that has a bottomed cylindrical shape and is made of resin, a second injection molding step of injection-molding a resin material into the intermediate molded body to produce a multilayer preform in which a resin layer is laminated on the intermediate molded body, and a blow molding step of blow-molding the multilayer preform in a state of having residual heat from injection molding to produce a resin container. The multilayer preform is formed such that a bottom portion is thicker than a body portion. In the blow molding step, at least one surface of the bottom portion of the multilayer preform is pressed with a mold, and a three-dimensional pattern corresponding to the mold is transferred to a thick bottom portion of the resin container.

### BACKGROUND OF THE INVENTION

### Field of the Invention

The present invention relates to a producing method and a producing apparatus for a resin container.

### Description of the Related Art

Containers for storing cosmetics, emulsions, and the like are required to have an appearance that can be worthy of aesthetic appreciation in order to increase the purchasing desire of a consumer. Glass bottles have a massive feeling and a luxurious feeling and are capable of maintaining a beautiful state even when used repeatedly, and thus are preferable as containers for storing this type of cosmetics and the like. However, a glass bottle is heavy and easily broken, and costs for transportation and production are high. Therefore, replacing a glass bottle with a resin container in a container for storing cosmetics and the like has been studied.

Herein, as one method for producing a resin container, a hot parison type blow molding method is known conventionally. In the hot parison type blow molding method, a resin container is blow-molded by using residual heat from injection molding of a preform. In the hot parison type blow molding method, the injection-molded preform is blow-molded without being detached from the machine. Thus, scratches do not easily form on the appearance of the container, and it is easy to design and adjust the shape of the preform to correspond to the shape of a container. Therefore, it is advantageous in that it is possible to produce a resin container which is diversified and excellent in aesthetic appearance as compared with a cold parison type.

In addition, in a resin container for storing cosmetics and the like, forming a three-dimensional pattern on the inner surface of the bottom portion for the purpose of improving the aesthetic appearance of the container, preventing agitation of the contents, and the like has been proposed (for example, JP 5-169521 A and JP 5035676 B2).

When a resin container is employed as a container for storing cosmetics or the like, it is desirable to mold the resin container into a shape having an equalized thickness by thickening the bottom portion and thinning the body portion, in order to emphasize a luxurious feeling and a massive feeling. However, when a three-dimensional pattern is formed on a thick container bottom portion, a preform having a thick bottom portion and high residual heat at the bottom portion is blow-molded. Therefore, it is difficult to accurately form the three-dimensional pattern while securing a predetermined thickness at the bottom portion which is easily deformed.

### SUMMARY OF THE INVENTION

According to an aspect of the present invention, a producing method for a resin container includes a first injection molding step of injection-molding an intermediate molded body that has a bottomed cylindrical shape and is made of resin, a second injection molding step of injection-molding a resin material into the intermediate molded body to produce a multilayer preform in which a resin layer is laminated on the intermediate molded body, and a blow molding step of blow-molding the multilayer preform in a state of having residual heat form injection molding to produce a resin container. The multilayer preform is formed such that a bottom portion is thicker than a body portion. In the blow molding step, at least one surface of the bottom portion of the multilayer preform is pressed with a mold, and a three-dimensional pattern corresponding to the mold is transferred to the thick bottom portion of the resin container.

Further features of the present invention will become apparent from the following description of exemplary embodiments with reference to the attached drawings.

### BRIEF DESCRIPTION OF THE DRAWINGS

FIGS. 1A and 1B are perspective views of a container according to a first embodiment.

FIG. 2A is a front view of the container in the first embodiment, and FIG. 2B is a longitudinal sectional view of the container in FIG. 2A.

FIG. 3 is a longitudinal sectional view of a preform in the first embodiment.

FIG. 4 is a view schematically illustrating a configuration of a blow molding apparatus in the first embodiment.

FIGS. 5A and 5B are views illustrating an example of a production step of the preform in the first embodiment.

FIGS. 6A and 6B are views illustrating a blow molding step in the first embodiment.

FIG. 7 is a flowchart illustrating steps of a producing method for the container.

FIG. 8 is a perspective view of a container according to a second embodiment.

FIG. 9A is a front view of the container in the second embodiment, and FIG. 9B is a longitudinal sectional view of the container in FIG. 9A.

FIGS. 10A and 10B are views illustrating a blow molding step in the second embodiment.

### DESCRIPTION OF THE EMBODIMENTS

Hereinafter, embodiments of the present invention will be described with reference to the drawings.

In the embodiments, for easy understanding, structures and elements other than the main parts of the present invention will be described with simplification and omission. In addition, in the drawings, the same elements are denoted by the same reference signs. Note that the shapes, dimensions, and the like of the respective elements illustrated in the drawings are schematically illustrated, and do not indicate actual shapes, dimensions, and the like.

### First Embodiment

### Configuration Example of Resin Container

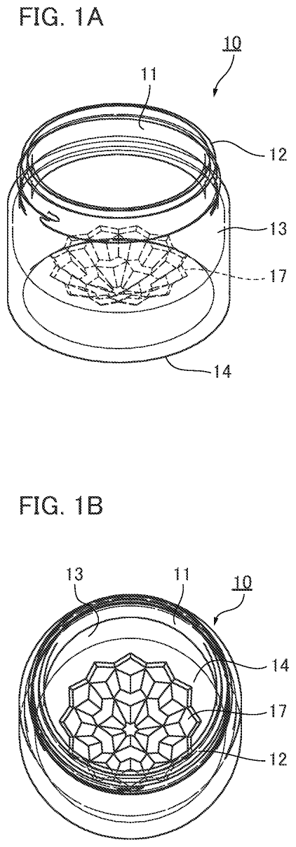

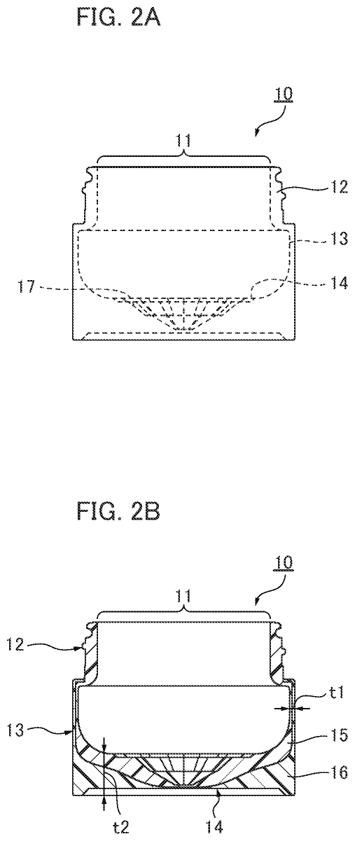

First, a configuration example of a resin container (also simply referred to below as a container) 10 according to a first embodiment will be described with reference to FIGS. 1A, 1B, 2A and 2B.

FIGS. 1A and 1B are perspective views of the container 10 in the first embodiment. FIG. 2A is a front view of the container 10 in the first embodiment. FIG. 2B is a longitudinal sectional view of the container 10 in FIG. 2A.

The entire shape of the container 10 illustrated in FIGS. 1 and 2 is a short cylindrical shape, and the container 10 has an opening on an upper surface side. The container 10 is formed of, for example, a resin material such as PET, and stores a lotion, an emulsion, or the like. The container 10 includes a neck portion 12 having a mouth portion 11 at an upper end, a body portion 13 that has a short cylindrical shape and is continuous from the neck portion 12, and a bottom portion 14 that is continuous from the body portion 13.

As illustrated in FIG. 2B, a thickness t2 of the bottom portion 14 of the container 10 is formed to be thicker than a thickness t1 of the body portion 13. That is, the thickness t1 of the body portion 13 is formed to be significantly thinner than the bottom portion 14, and the thickness of the body portion 13 is equalized. Although not particularly limited, the thickness t2 of the bottom portion 14 of the container 10 is set to be equal to or more than 6 mm (6 mm to 15 mm), and preferably equal to or more than 10 mm, for example (10 mm to 15 mm).

By forming the container 10 into a shape having the above-described thickness distribution, a luxurious feeling and a massive feeling are emphasized, and it is possible to bring the container 10 close to an image of a cosmetic container held by a consumer. That is, since it is possible to improve the aesthetic appearance of the container 10, it is possible to use the container 10 as a cosmetic container or the like having an appearance that is important.

As illustrated in FIG. 2B, the body portion 13 and the bottom portion 14 of the container 10 have a structure in which a first layer 15 facing a container inner surface and a second layer 16 facing a container outer surface are laminated. This structure is formed by blow-molding a preform 20 to be described later.

In the first embodiment, as illustrated in FIGS. 1B and 2B, a three-dimensional pattern 17 is attached to the inner surface side of the bottom portion 14 of the container 10. The three-dimensional pattern 17 is a recess that is recessed downward from the container inner surface of the bottom portion 14 toward the inside of the bottom portion 14. The three-dimensional pattern 17 is formed in, for example, a diamond shape (polyhedron group shape), a flower crown, or the like. By forming the three-dimensional pattern 17 on the bottom portion 14 of the container 10, it is possible to further improve the aesthetic appearance of the container 10, and to further increase the desire to purchase a product.

Further, when the container 10 (specifically, the contents of the container 10) has translucency, the three-dimensional pattern 17 such as a diamond shape or a flower crown illustrated in FIGS. 1 and 2 also has a function of enhancing a luxurious feeling of the container 10 by an effect of causing scattering of incident light at a portion of the three-dimensional pattern 17. Note that the shape of the three-dimensional pattern 17 is not limited to the examples of FIGS. 1 and 2, and can be appropriately changed.

### Configuration Example of Preform

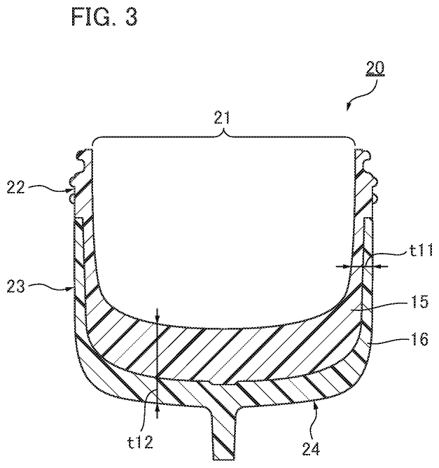

FIG. 3 is a longitudinal sectional view of the preform (multilayer preform, bilayer preform) 20 applied to the production of the container 10 in the first embodiment.

The entire shape of the preform 20 is a bottomed cylindrical shape that is opened at a mouth portion 21 on one end side and closed on the other end side. The preform 20 includes a body portion 23 formed in a cylindrical shape, a bottom portion 24 that closes the other end side of the body portion 23, and a neck portion 22 that is formed on one end side of the body portion 23 and has the mouth portion 21. Note that, in the preform 20 of FIG. 3, the axial length of the body portion 23 is set to be short to correspond to the container 10 having a short cylindrical shape.

The preform 20 has a structure in which a first layer 15 located on an inner peripheral side and a second layer 16 located on an outer peripheral side are laminated. The neck portion 22 is made of a material of the first layer 15, but the body portion 23 and the bottom portion 24 are configured by laminating the second layer 16 on the outer periphery of the first layer 15.

The preform 20 of FIG. 3 is formed in a manner as follows. First, an intermediate molded body 20A including a neck portion 22, a body portion 23, and a bottom portion 24 is injection-molded with the material of the first layer 15. Thereafter, a material of the second layer 16 is further injection-molded on the outer peripheries of the body portion 23 and the bottom portion 24 of the intermediate molded body 20A, thereby forming the preform 20.

Here, the compositions of the materials of the first layer 15 and the second layer 16 may be the same or different. For example, the same resin material may be used for the first layer 15 and the second layer 16, or different materials may be used. In addition, for example, the amount of coloring material (color shade), the type of coloring material (color type), and the like may be changed for each of the materials of the first layer 15 and the second layer 16. Note that at least one of the first layer 15 and the second layer 16 (preferably both the first layer 15 and the second layer 16) may have a property of transmitting light (translucency or transparency).

In the example of FIG. 3, in order to shape the container 10 having a thick bottom, the preform 20 in which a thickness t12 of the bottom portion 24 is twice a thickness t11 of the body portion 23 or more is applied. In addition, the dimensions and specifications of the preform 20, for example, the thicknesses of the first layer 15 and the second layer 16 can be appropriately changed in accordance with the shape of the container 10 to be produced. Note that the axial length of the entire preform 20 (the length from the upper end of the neck portion 22 to the lower end of the second layer 16 of the bottom portion 24) is desirably set to be longer than that of the container 10. Further, a gate portion (an introduction mark of the material of the second layer 16) extending downward from the bottom portion 24 may be removed before blow molding.

(Description of Producing Apparatus for Container)

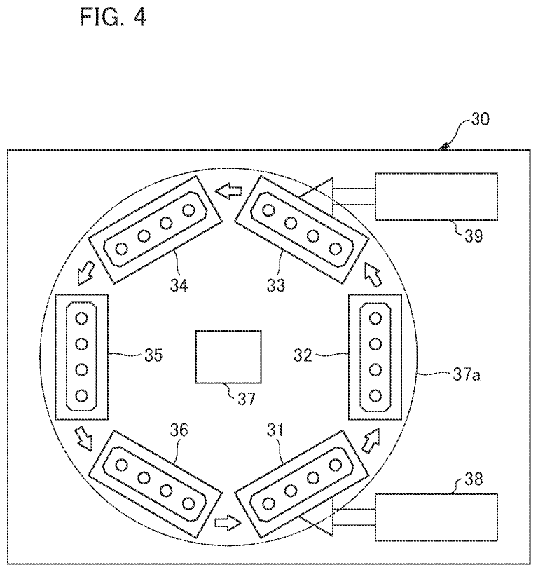

FIG. 4 is a view schematically illustrating a configuration of a blow molding apparatus 30 in the first embodiment. The blow molding apparatus 30 in the first embodiment is an example of a producing apparatus for a container, and employs a hot parison method (also referred to as a one-stage method) in which a container is blow-molded by utilizing residual heat (internal heat quantity) from injection molding without cooling the preform 20 to room temperature.

The blow molding apparatus 30 includes a first injection molding unit 31, a first temperature adjustment unit 32, a second injection molding unit 33, a second temperature adjustment unit 34, a blow molding unit 35, a taking-out unit 36, and a transport mechanism 37. The first injection molding unit 31, the first temperature adjustment unit 32, the second injection molding unit 33, the second temperature adjustment unit 34, the blow molding unit 35, and the taking-out unit 36 are disposed at positions rotated by a predetermined angle (for example, 60 degrees) about the transport mechanism 37. Note that the blow molding apparatus 30 may be configured to omit the first temperature adjustment unit 32.

(Transport Mechanism 37)

The transport mechanism 37 includes a conveyance plate 37a that moves to rotate about an axis in a direction perpendicular to the paper surface of FIG. 4. In the conveyance plate 37a, one or more neck molds 37b (not illustrated in FIGS. 1A and 1B) for holding the neck portion 22 of the preform 20 (or the neck portion 12 of the container 10) are arranged at each predetermined angle. By moving the conveyance plate 37a by 60 degrees, the transport mechanism 37 transports the preform 20 (or the container 10) having the neck portion 22 held by the neck mold 37b to the first injection molding unit 31, the first temperature adjustment unit 32, the second injection molding unit 33, the second temperature adjustment unit 34, the blow molding unit 35, and the taking-out unit 36 in this order. When the first temperature adjustment unit 32 is omitted from the blow molding apparatus 30, the transport mechanism 37 moves the conveyance plate 37a by 72 degrees to transport the preform 20 (or the container 10) in the order of the first injection molding unit 31, the second injection molding unit 33, the second temperature adjustment unit 34, the blow molding unit 35, and the taking-out unit 36.

Note that the transport mechanism 37 further includes a lifting mechanism (vertical mold opening/closing mechanism) and a mold opening mechanism of the neck mold 37b, and performs an operation of lifting and lowering the conveyance plate 37a and an operation related to mold closing and mold opening (mold separation) in the injection molding unit 31 and the like.

(First Injection Molding Unit 31)

The first injection molding unit 31 includes an injection cavity mold 40, an injection core mold 41, and a hot runner mold 42, and produces the intermediate molded body 20A of the preform 20. As illustrated in FIG. 4, the first injection molding unit 31 is connected with a first injection device 38 that supplies a resin material (first resin material) for forming the first layer 15 to the hot runner mold 42.

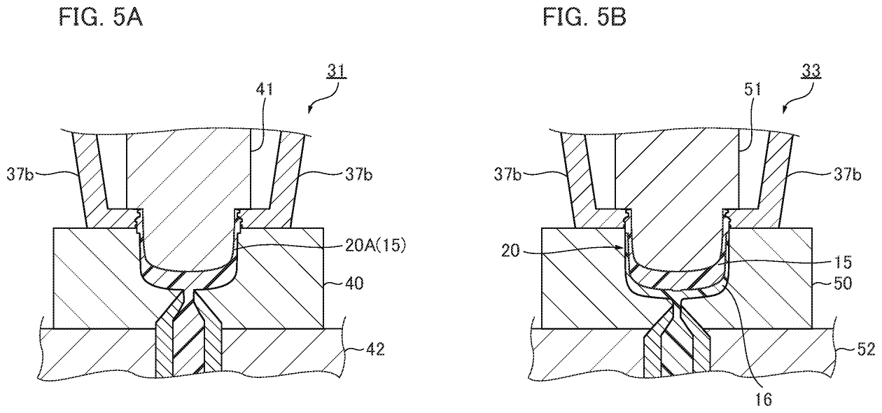

FIG. 5A illustrates an injection molding step in the first injection molding unit 31. In the first injection molding unit 31, the injection cavity mold 40, the injection core mold 41, and the neck mold 37b of the transport mechanism 37 are closed to form a mold space for the first layer 15. Then, by pouring the first resin material from the first injection device 38 into the mold space via the hot runner mold 42, the intermediate molded body (single layer preform) 20A corresponding to the first layer 15 is produced in the first injection molding unit 31.

Here, the first resin material is a thermoplastic synthetic resin, and can be appropriately selected in accordance with the specifications of the container 10. Specific examples of the type of material include PET (polyethylene terephthalate), PEN (polyethylene naphthalate), PCTA (polycyclohexane dimethylene terephthalate), Tritan (registered trademark: copolyester produced by Eastman Chemical Co., Ltd.), PP (polypropylene), PE (polyethylene), PC (polycarbonate), PES (polyether sulfone), PPSU (polyphenyl sulfone), PS (polystyrene), COP/COC (cyclic olefin polymer), PMMA (polymethyl methacrylate: acrylic), PLA (polylactic acid), and the like. In addition, an additive such as a coloring material may be added to the first resin material. Although not particularly limited, it is preferable to apply PET as the first resin material in consideration of having translucency and low material cost.

Note that, even when the mold of the first injection molding unit 31 is opened, the neck mold 37b of the transport mechanism 37 is not opened, and, in this state, the intermediate molded body 20A is held and transported. The number of intermediate molded bodies 20A simultaneously molded by the first injection molding unit 31 (that is, the number of containers 10 that can be simultaneously molded by the blow molding apparatus 30) can be appropriately set.

(First Temperature Adjustment Unit 32)

The first temperature adjustment unit 32 includes a temperature adjustment mold (not illustrated) (a heating pot or a temperature adjustment pot (temperature-controlled pot) for externally adjusting the temperature of the intermediate molded body 20A, and a heating rod, a temperature adjustment rod (temperature-controlled rod), or an air introduction rod for internally adjusting the temperature of the preform 20). The first temperature adjustment unit 32 cools (or heats) the intermediate molded body 20A in a high temperature state after injection molding, by accommodating the intermediate molded body in a temperature adjustment mold maintained at a predetermined temperature. In addition, the first temperature adjustment unit 32 also has a function of adjusting the temperature distribution of the intermediate molded body 20A to a predetermined state before being transported to the second injection molding unit 33.

(Second Injection Molding Unit 33)

The second injection molding unit 33 includes an injection cavity mold 50, an injection core mold 51, and a hot runner mold 52, and injection-molds the second layer 16 on the outer peripheral portion of the first layer 15. As illustrated in FIG. 4, the second injection molding unit 33 is connected with a second injection device 39 that supplies a resin material (second resin material) for forming the second layer 16 to the hot runner mold 52.

FIG. 5B illustrates an injection molding step in the second injection molding unit 33.

The injection cavity mold 50 of the second injection molding unit 33 accommodates the intermediate molded body 20A that has been injection-molded by the first injection molding unit 31. In a state where the molds of second injection molding unit 33 are closed, a mold space is formed between the inner surface of the injection cavity mold 50 and the outer peripheral side of the intermediate molded body 20A from the body portion to the bottom portion, that is the first layer 15. By filling the mold space with the second resin material from the second injection device 39 via the hot runner mold 52, the second layer 16 is molded on the outer periphery of the intermediate molded body 20A that is the first layer 15. As a result, the second layer 16 is laminated on the outer peripheral side of the first layer 15, and the preform (multilayer preform, bilayer preform) 20 of FIG. 3 is produced.

The second resin material is a thermoplastic synthetic resin, and the specific type of the material is similar to that of the first resin material. The composition of the second resin material may be the same as or different from that of the first resin material. For example, the same resin material may be used for the first layer 15 and the second layer 16, or different materials may be used. Furthermore, for example, the amount of coloring material, the type of coloring material, and the like may be changed for each of the materials of the first layer 15 and the second layer 16. Although not particularly limited, it is preferable to also apply PET as the second resin material in consideration of having translucency and low material cost.

(Second Temperature Adjustment Unit 34)

The second temperature adjustment unit 34 includes a temperature adjustment mold (not illustrated) (a heating pot or a temperature adjustment pot (temperature-controlled pot) for externally adjusting the temperature of the preform 20, and a heating rod, a temperature adjustment rod (temperature-controlled rod), or an air introduction rod for internally adjusting the temperature of the preform 20). The second temperature adjustment unit 34 performs temperature equalization and removal of an uneven temperature of the preform 20 that has been injection-molded by a temperature adjustment mold, and adjusts the temperature of the preform 20 to a temperature suitable for blow molding (for example, about 90° C. to 105° C.) and a temperature distribution suitable for a container shape to be shaped. In addition, the second temperature adjustment unit 34 also has a function of cooling the preform 20 in a high temperature state after injection molding.

(Blow Molding Unit 35)

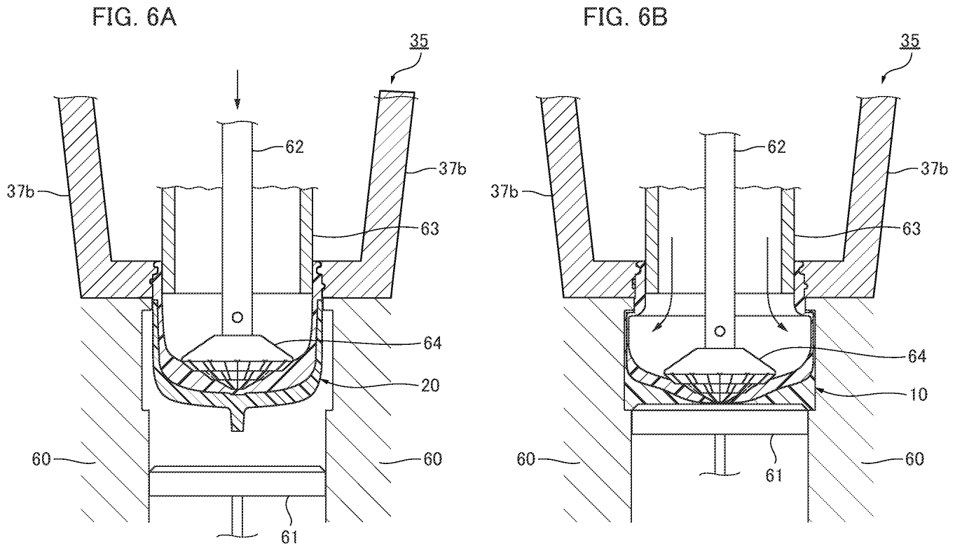

The blow molding unit 35 blow-molds the preform 20 having a temperature that has been adjusted by the second temperature adjustment unit 34. In this manner the container 10 is produced. FIGS. 6A and 6B illustrate a blow molding step in the blow molding unit 35. The blow molding unit 35 includes a blow cavity mold 60, a bottom mold 61, a stretching rod 62, and an air introduction member (blow core) 63.

The blow cavity mold 60 is a pair of split molds that defines the shape of the container 10 excluding the bottom surface. The blow cavity mold 60 is divided by a parting surface (not illustrated) along the vertical direction in FIGS. 6A and 6B, and is configured to be openable and closable in the horizontal direction in FIGS. 6A and 6B. The bottom mold 61 is a mold material that is disposed on a lower side of the blow cavity mold 60 and defines the shape of the bottom surface of the container 10. When the blow cavity mold 60 and the bottom mold 61 are closed, a mold space for defining the shape of the container 10 is formed.

The stretching rod 62 and the air introduction member (blow core) 63 are configured to be movable forward and backward in the axial direction with respect to the neck mold 37b that holds the preform 20. The stretching rod 62 presses the bottom portion 24 of the preform 20 from the inside, and stretches preform 20 in a direction of the longitudinal axis as necessary.

A pressing piece 64 that has a protrusion having a shape corresponding to the three-dimensional pattern 17 and transfers the shape of the three-dimensional pattern 17 to the bottom portion 14 of the container 10 is attached to the distal end of the stretching rod 62. In order to insert the pressing piece 64 into the preform 20, the outer diameter of the pressing piece 64 is set to be less than the inner diameter of the mouth portion 21 (or the body portion 23 or the bottom portion 24) of the preform 20. Note that, from the viewpoint of forming the three-dimensional pattern 17 in a wide range on the inner surface of the preform 20 and alleviating stress concentration due to pressing of the pressing piece 64, the outer diameter of the pressing piece 64 is preferably equal to or more than ⅔ and equal to or less than ⅘ of the inner diameter of the mouth portion 21 (or the body portion 23 or the bottom portion 24) of the preform 20.

Further, in order to avoid interference between the air introduction member (blow core) 63 and the pressing piece 64 when the stretching rod 62 is raised and retracted, after the blow molding, the diameter of the pressing piece 64 is preferably set to be less than the inner diameter of the air introduction member (blow core) 63.

The air introduction member 63 is in close contact with the inner periphery of the neck portion 22 of the preform 20 in a state of being inserted into the neck mold 37b, and maintains airtightness with the preform 20 (or the container 10). In addition, the air introduction member 63 introduces blow air supplied from a compressor (not illustrated) into the preform 20 during blow molding.

In the blow molding unit 35, the preform 20 is accommodated in a mold space formed by the blow cavity mold 60 and the bottom mold 61. Then, in the blow molding unit 35, the blow air from the air introduction member 63 is introduced into the preform 20 while the preform 20 is stretched by the stretching rod 62. As a result, the blow molding unit 35 can produce the container 10 by shaping the preform 20 into the shape of the mold space. Note that the shape of the three-dimensional pattern 17 is transferred to the inner surface side of the bottom portion 14 of the container 10 by the pressing piece 64 of the stretching rod 62.

Note that there is a case where the length of the container 10 is substantially equal to or shorter than the length of the preform 20 (case where the longitudinal-axis stretching ratio of the preform to the container may be 0.8 to 1.2 (particularly case of 0.9 to 1.1)). In the above case, either a lowering operation of the pressing piece 64 or a lifting operation of the bottom mold 61 may be performed earlier. That is, either the pressing piece 64 or the bottom mold 61 may come into contact with the preform 20 first. When the bottom portion 24 of the preform 20 is sandwiched and pressed between the bottom mold 61 and the pressing piece 64, the three-dimensional pattern is transferred to the inner surface of the bottom portion of the container 10 (or the outer surface of the bottom portion as described later).

(Taking-out Unit 36)

The taking-out unit 36 is configured to open the neck portion 12 of the container 10 produced by the blow molding unit 35 from the neck mold 37b and extract the container 10 to the outside of the blow molding apparatus 30.

(Description of Producing Method for Container)

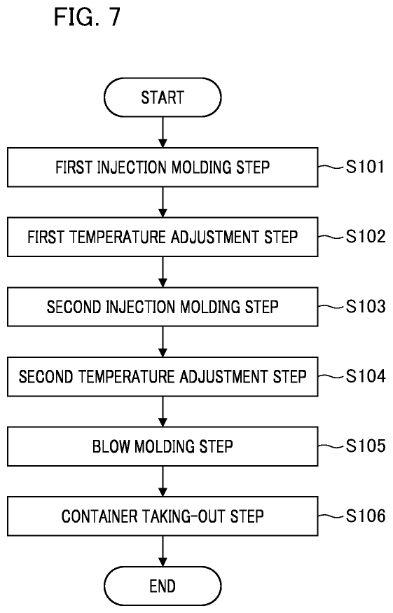

Next, a producing method for a container by the blow molding apparatus 30 in the present embodiment will be described. FIG. 7 is a flowchart illustrating steps of the producing method for the container.

(Step S101: First Injection Molding Step)

First, the first injection molding unit 31 injects the resin material from the first injection device 38 into the mold space of the intermediate molded body 20A formed by the injection cavity mold 40, the injection core mold 41, and the neck mold 37b of the transport mechanism 37. As a result, as illustrated in FIG. 5A, an intermediate molded body 20A corresponding to the first layer 15 of the preform 20 is produced.

When the injection molding of the first layer 15 is completed, the first injection molding unit 31 is opened, and the intermediate molded body 20A is separated from the injection cavity mold 40 and the injection core mold 41. Then, the conveyance plate 37a of the transport mechanism 37 moves to rotate by a predetermined angle.

As a result, the intermediate molded body 20A held by the neck mold 37b is transported to the first temperature adjustment unit 32 in a state of containing residual heat from injection molding. At this time, the intermediate molded body 20A is in contact with air while being transported from the first injection molding unit 31 to the first temperature adjustment unit 32. As a result, the intermediate molded body 20A is slightly cooled from the outer surface, and temperature equalization by heat exchange (heat conduction) proceeds between a skin layer (surface layer in a solidified state) and a core layer (internal layer in a softened or molten state).

(Step S102: First Temperature Adjustment Step)

Then, in the first temperature adjustment unit 32, the intermediate molded body 20A is accommodated in the temperature adjustment mold, and the cooling of the first layer 15 and the adjustment of the temperature distribution (temperature equalization and removal of the uneven temperature) are performed. With the first temperature adjustment step, in the intermediate molded body 20A, temperature equalization by heat exchange (heat conduction) proceeds between the skin layer and the core layer. Note that the first temperature adjustment step may be omitted.

After the first temperature adjustment step (or the first injection molding step), the conveyance plate 37a of the transport mechanism 37 moves to rotate by a predetermined angle, and the intermediate molded body 20A after temperature adjustment, which has been held by the neck mold 37b, is transported to the second injection molding unit 33. The intermediate molded body 20A is brought into contact with air even while being transported from the first temperature adjustment unit 32 to the second injection molding unit 33. Thus, the intermediate molded body is slightly cooled from the outer surface, and temperature equalization by heat exchange (heat conduction) proceeds between the skin layer and the core layer.

(Step S103: Second Injection Molding Step)

Subsequently, in the second injection molding unit 33, the intermediate molded body 20A is accommodated inside the injection cavity mold 50, and then a resin material is injected from the second injection device 39 between the outer periphery of the intermediate molded body 20A and the injection cavity mold 50. As a result, as illustrated in FIG. 5B, the second layer 16 is formed on the outer peripheral portion of the intermediate molded body 20A, and the preform 20 is produced.

When the injection molding of the second layer 16 is completed, the second injection molding unit 33 is opened, and the preform 20 is separated from the injection cavity mold 50 and the injection core mold 51. Then, the conveyance plate 37a of the transport mechanism 37 moves to rotate by a predetermined angle. As a result, the preform 20 held by the neck mold 37b is transported to the second temperature adjustment unit 34 in a state of containing residual heat from injection molding.

(Step S104: Second Temperature Adjustment Step)

Subsequently, in the second temperature adjustment unit 34, the preform 20 is accommodated in the temperature adjustment mold, and temperature adjustment for bringing the temperature of the preform 20 close to a temperature suitable for the final blow is performed.

After the second temperature adjustment step, the conveyance plate 37a of the transport mechanism 37 moves to rotate by a predetermined angle, and the preform 20 after temperature adjustment, which has been held in the neck mold 37b, is transported to the blow molding unit 35.

(Step S105: Blow Molding Step)

Subsequently, in the blow molding unit 35, the container 10 is blow-molded.

First, the blow cavity mold 60 is closed, the preform 20 is accommodated in the mold space, and the air introduction member 63 is lowered, so that the air introduction member 63 abuts on the neck portion 22 of the preform 20. Then, the stretching rod 62 is lowered to hold the bottom portion 24 of the preform 20 from the inner surface, and longitudinal-axis stretching is performed as necessary (FIG. 6A).

Then, by supplying the blow air from the air introduction member 63, the preform 20 is stretched in the lateral axis (FIG. 6B). As a result, the preform 20 is bulged and shaped to be in close contact with the mold space of the blow cavity mold 60, and is blow-molded into the container 10. Note that, when the preform 20 is longer than the container 10, the bottom mold 61 may be made to stand by at a lower position that is not in contact with the bottom portion 24 of the preform 20 before closing the blow cavity mold 60, and may be quickly raised to a molding position after the mold is closed.

In addition, during blow molding, the pressing piece 64 of the stretching rod 62 comes into contact with the bottom portion 24 of the preform 20, so that the shape of the three-dimensional pattern 17 is transferred to the inner surface side of the bottom portion 14 of the container 10.

Note that, as described above, the bottom mold 61 may be brought into contact with the preform 20, and then the stretching rod 62 may be lowered to press the pressing piece 64 against the preform 20.

(Step S106: Container Taking-out Step)

When the blow molding is completed, the blow cavity mold 60 and the bottom mold 61 are opened. As a result, the container 10 is movable from the blow molding unit 35.

Subsequently, the conveyance plate 37a of the transport mechanism 37 moves to rotate by a predetermined angle, and the container 10 is transported to the taking-out unit 36. In the taking-out unit 36, the neck portion 12 of the container 10 is opened from the neck mold 37b, and the container 10 is extracted to the outside of the blow molding apparatus 30.

With the above description, one cycle in the producing method for the container is ended. Thereafter, the conveyance plate 37a of the transport mechanism 37 is moved to rotate by a predetermined angle, thereby the respective steps of S101 to S105 described above are repeated. Note that, during the operation of the blow molding apparatus 30, six sets (five sets when the first temperature adjustment step is omitted) of container production having a time difference of one step are performed in parallel.

Further, due to the structure of the blow molding apparatus 30, the respective times of the first injection molding step, the second injection molding step, the temperature adjustment step, the blow molding step, and the container taking-out step have the same length. Similarly, the transport times between the steps have the same length.

Effects of the first embodiment will be described below.

In the first embodiment, in order to blow-mold a thick container 10 suitable for a cosmetic container or the like, a preform 20 having a thick bottom portion 24 is produced by two injection molding steps. Then, in the blow molding step, the three-dimensional pattern 17 is formed on the inner surface of the bottom portion 14 of the container 10 by the pressing piece 64 of the stretching rod 62.

In general, since the residual heat of the preform increases in proportion to the thickness of the preform, the preform is more likely to deform in a thicker portion. Therefore, in a case where a preform having a thick portion is molded by one injection molding and a three-dimensional pattern is transferred to the thick portion, and when the thick portion is stretched by blow molding, for example, it is not possible to keep the thick portion to a predetermined thickness or more, or the inner surface of the thick portion tends to be uneven. Furthermore, since the thick portion is likely to be insufficiently cooled, molding defects such as sink marks, bubbles, and whitening (crystallization) may occur in the three-dimensional pattern (or the thick portion where the three-dimensional pattern is formed).

For example, when the material is PET, the maximum thickness of the preform, which enables suppression of an occurrence of defects such as whitening, is limited to about 9 mm. when the container is molded from the preform, the preform is slightly stretched (stretched at least in the horizontal axis direction). Thus, the thickness of the bottom portion of the container has a numerical value that is equal to or less than the maximum thickness (for example, about 5 mm) even at most.

On the other hand, in the first embodiment, the preform 20 is injection-molded twice as described above, and the second layer 16 is laminated on the intermediate molded body 20A that comes into contact with air during transport and has the adjusted temperature. As a result, in the preform 20 in the first embodiment, the internal residual heat can be reduced even though the bottom portion 24 is thick, as compared with the preform produced in one injection molding step. Therefore, it is possible to easily adjust the deformation amount of the thick bottom portion 24 in the blow molding step, and to accurately form the three-dimensional pattern 17 on the bottom portion 14 of the container 10.

Furthermore, the thick bottom portion of the container is partially recessed (specifically, the central region of the bottom portion) and formed to be thin by the length of the three-dimensional pattern of the pressing piece 64. Since a distance from the bottom mold surface to the inside (core layer) of the central region of the thick bottom portion, which has the most residual heat and is most difficult to be cooled during blow molding, can be shortened, it is possible to enhance the cooling efficiency of the bottom portion of the container and to easily suppress the occurrence of whitening of the bottom portion of the container.

In addition, in the first embodiment, each preform injected in the first injection molding step and the second injection molding step is thinner than the thickness when the thick preform is molded in one injection molding step, and the difficulty in injection molding is also lowered. Furthermore, it is possible to separately adjust a parameter such as a cooling time in each injection molding step. Therefore, in the first embodiment, since the thick preform 20 suitable for the specifications of the container 10 can be easily molded, it is possible to improve the quality of the container 10.

For example, even when the thickness of each of the first layer and the second layer formed in the first injection molding step and the second injection molding step is set to 8 mm, the thickness of the bottom portion of the preform can be formed to 16 mm while the occurrence of whitening is suppressed. In addition, the bottom portion of the container can be easily formed to a thickness of about 10 mm (here, a portion where the three-dimensional pattern is formed is excluded).

Furthermore, in the first embodiment, the injection/cooling time in each of the first injection molding step and the second injection molding step is shorter than the injection/cooling time when the thick preform is molded in one injection molding step. As a result, since the injection/cooling time of the preform, which is the rate-determining stage, is shortened, it is possible to also shorten a molding cycle when the thick container 10 suitable for a cosmetic container or the like is produced.

Note that, in the present embodiment, since the preform 20 is produced by two injection molding steps, the coloring of the first layer 15 and the second layer 16 of the preform 20 can be made different. By applying the three-dimensional pattern 17 to the container 10, it is possible to further enhance the design of the container 10.

### Second Embodiment

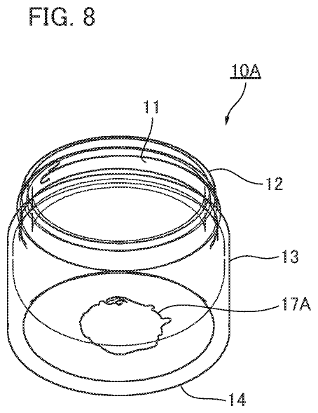

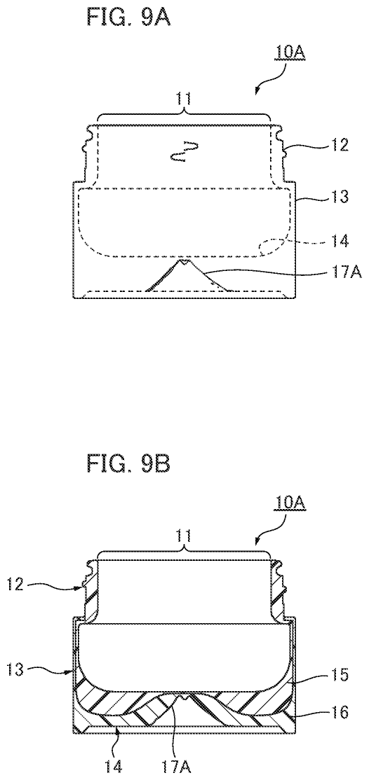

Next, a second embodiment will be described. FIGS. 8 and 9 are views illustrating a container 10A in the second embodiment. In the following description, the same elements as those of the first embodiment are denoted by the same reference signs, and repetitive description will be omitted.

As illustrated in FIGS. 8 and 9, in the second embodiment, a three-dimensional pattern 17A, which is an example of a three-dimensional pattern, is attached to the outer surface side of a bottom portion 14 of the container 10A. The three-dimensional pattern 17A is a recess that is recessed upward from the container outer surface of the bottom portion 14 toward the inside of the bottom portion 14, and is formed in a shape imitating the appearance of a mountain, for example. Note that other components of the container 10A are similar to those of the first embodiment.

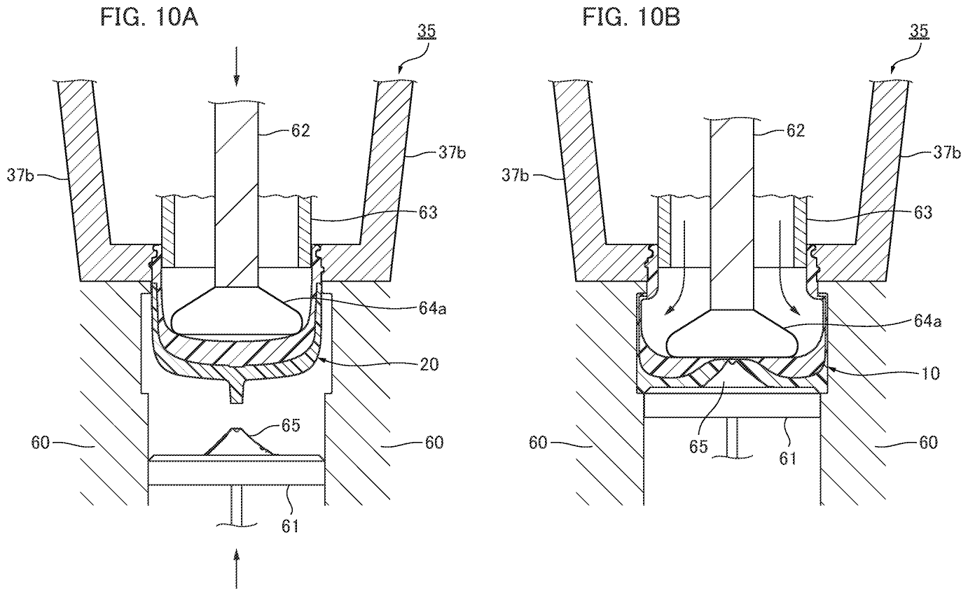

A producing method for the container 10A in the second embodiment is similar to that in the first embodiment except for a blow molding step. FIGS. 10A and 10B illustrate the blow molding step in a blow molding unit 35 in the second embodiment.

In the second embodiment, a protrusion 65 having a shape corresponding to the three-dimensional pattern 17A is formed on the upper surface of a bottom mold 61 facing a preform 20. Note that a distal end piece 64a having a flat distal end is attached to a distal end portion of a stretching rod 62 illustrated in FIGS. 10A and 10B. Unlike the pressing piece 64, the distal end piece 64a does not transfer the shape of the three-dimensional pattern. However, when it is desired to also add a three-dimensional pattern to the inner surface side of the bottom portion 14, a pressing piece 64 that transfers the shape of the three-dimensional pattern may be attached to the stretching rod 62.

In the blow molding unit 35 in the second embodiment, after an air introduction member 63 is caused to abut on the neck portion 22 of the preform 20, the stretching rod 62 is lowered and the bottom mold 61 is lift (FIG. 10A). As a result, the bottom portion 24 of the preform 20 is pressed against a bottom mold 61 having the protrusion 65 on the upper surface side.

When the blow air from the air introduction member 63 is introduced into the preform 20, the preform 20 is bulged and shaped to be in close contact with a mold space of a blow cavity mold 60, and is blow-molded into the container 10A. Note that the shape of the three-dimensional pattern 17A is transferred to the outer surface side of the bottom portion 14 of the container 10A by the protrusion 65 of the bottom mold 61.

Also in the second embodiment, it is possible to obtain substantially the similar effects to those of the first embodiment.

The present invention is not limited to the above embodiments, and various improvements and design changes may be made without departing from the gist of the present invention.

In the above embodiments, the example in which the three-dimensional pattern is formed on either the inner surface side or the outer surface side of the thick bottom portion of the container has been described. However, in the present invention, the three-dimensional pattern may be formed on both the inner surface side and the outer surface side of the thick bottom portion of the container.

Further, in the above embodiments, the example in which the preform is produced by laminating the second layer on the outer side of the first layer in the second injection molding step has been described. However, in the present invention, the preform may be produced by laminating the second layer on the inner side of the first layer in the second injection molding step. In this case, in the first injection molding step, a thin film portion is formed at the center of the bottom portion of the intermediate molded body by pressing of a pin or the like. Then, in the second injection molding step, the thin film portion may be broken by injection of resin, and the resin may be introduced into the intermediate molded body.

In addition, the embodiments disclosed herein are to be considered in all respects as illustrative and not restrictive. The scope of the present invention is indicated not by the above description but by the claims, and it is intended that meanings equivalent to the claims and all modifications within the scope are included.

1. A producing method for a resin container, the method comprising:
first injection-molding an intermediate molded body that has a bottomed cylindrical shape and is made of resin;
injecting a resin material at the intermediate molded body to mold a multilayer preform in which a resin layer is laminated on the intermediate molded body as second injection-molding; and
blow-molding the multilayer preform in a state of having residual heat from injection molding to produce a resin container, wherein
the multilayer preform is formed such that a bottom portion is thicker than a body portion, and
in the blow molding, at least one surface of the bottom portion of the multilayer preform is pressed with a mold, and a three-dimensional pattern corresponding to the mold is transferred to a thick bottom portion of the resin container.

2. The producing method for a resin container according to claim 1, wherein
the mold is attached to a distal end of a stretching rod, and
the three-dimensional pattern is transferred to a container inner surface side of the thick bottom portion.

3. The producing method for a resin container according to claim 2, wherein
an outer diameter of the mold is equal to or more than ⅔ of an inner diameter of the multilayer preform.

4. The producing method for a resin container according to claim 1, wherein
the mold is a bottom mold facing an outer periphery of a bottom surface of the multilayer preform, and
the three-dimensional pattern is transferred to a container outer surface side of the thick bottom portion.

5. The producing method for a resin container according to claim 1, wherein
a thickness of a bottom portion of the resin container is equal to or more than 10 mm.

6. A producing apparatus for a resin container, the apparatus comprising:
a first injection molding unit configured to injection-mold an intermediate molded body that has a bottomed cylindrical shape and is made of resin;
a second injection molding unit configured to inject a resin material at the intermediate molded body to mold a multilayer preform in which a resin layer is laminated on the intermediate molded body; and
a blow molding unit configured to blow-mold the multilayer preform in a state of having residual heat from injection molding to produce a resin container, wherein
the multilayer preform is formed such that a bottom portion is thicker than a body portion, and
the blow molding unit presses at least one surface of the bottom portion of the multilayer preform with a mold, and transfers a three-dimensional pattern corresponding to the mold to a thick bottom portion of the resin container.
